(19) United States
(12) Patent Application Publication
(10) Pub. No.: US 2012/0311308 A1
(43) Pub. Date: Dec. 6, 2012

(54) Branch Predictor with Jump Ahead Logic to Jump Over Portions of Program Code Lacking Branches

(76) Inventors: Polychronis Xekalakis, Barcelona (ES); Pedro Marcuello, Barcelona (ES); Fernando Latorre, Barcelona (ES)

(21) Appl. No.: 13/150,970

(22) Filed: Jun. 1, 2011

(51) Int. Cl. G06F 9/38

(52) U.S. Cl. 712/239; 712/E09.045

(57) ABSTRACT

A processor of an aspect includes front end logic to process parcels of program code. Each of the parcels has multiple instructions. A branch predictor of the processor is coupled with the front end logic. The branch predictor is to predict directions of branch instructions of the program code. The processor includes jump ahead logic to cause the branch predictor to jump over at least one parcel of the program code that does not have a branch instruction between parcels of the program code that each have at least one branch instruction.

### BACKGROUND

1. Field

Embodiments of the invention relate to the field of branch prediction. In particular, embodiments of the invention relate to a branch predictor having jump ahead logic to allow the branch predictor to jump over portions of program code that lack branches.

2. Background Information

Assembly code or machine code executed by processors typically contains branches. The branches may represent conditional jump instructions, conditional branch instructions, or other types of branch instructions or branches. Commonly, the branches may cause the flow of execution to branch in one of two possible directions. These two directions are often called a “taken branch” and a “not taken branch”. The “not taken branch” commonly leads to the next sequential portion of code being executed, whereas the “taken branch” commonly leads to a jump or branch to a different, non-sequential portion of program code. In the case of conditional branches, whether the branches are taken or not taken may depend upon the outcomes of conditions associated with the instructions (e.g., whether one value is greater than another, etc.), which are to be evaluated later during execution stage of the processor pipeline.

Processors commonly have branch predictors to help predict the directions of the branches before the actual directions of the branches have been determined. It is not actually known definitively whether a conditional branch will be taken or not taken until the condition has been evaluated in the execution stage of the instruction pipeline. However, the branch predictors may employ prediction mechanisms or logic to predict the directions of the branches, for example based on past execution history, in order to help improve processor performance. Without the branch predictors, the processor would have to wait until the branches have been actually evaluated before the next set of instructions could be fetched into the pipeline. The branch predictor helps to avoid this waste of time by trying to predict whether the branch is more likely to be taken or not taken. The predicted branch direction may then be used to fetch a set of instructions so that they can be readied for execution and/or speculatively executed before the actual direction of the branch has been evaluated. In the case of speculatively executed instructions, if it is later determined that the predicted direction of the branch was incorrect, then the speculatively executed results/state may be discarded, and execution may be rewound back to the branch with the actual direction of the branch now known.

Branch predictors are important components of processors in part because they help to provide a continual stream of instructions to the execution stage of the processor pipeline. Without the branch predictors, the processor may be unable to fetch a sufficient number of instructions per cycle for the execution and back-end stages to process, which may tend to limit performance. In addition, branch predictors typically should make accurate predictions to help to avoid costly incorrect predictions, and should be fast enough to stay ahead of the execution stage of the processor pipeline so that predicted directions of branches can be made and utilized ahead of actual execution.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 is a block diagram of an example embodiment of a processor.

FIG. 2 illustrates an example portion of program code having fetch parcels (FP) with and without branch instructions.

FIG. 3 is a block flow diagram of an example embodiment of vention method of jumping over parcels that omit branches during branch prediction.

FIG. 4 is a block diagram of an example embodiment of a decoupled branch predictor.

FIG. 5 is a block diagram of an example embodiment of a suitable fetch target buffer.

FIG. 6 is a block diagram of an example embodiment of a suitable fetch queue.

FIG. 7 is a block diagram of an example embodiment of a computer system or electronic device suitable for incorporating embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

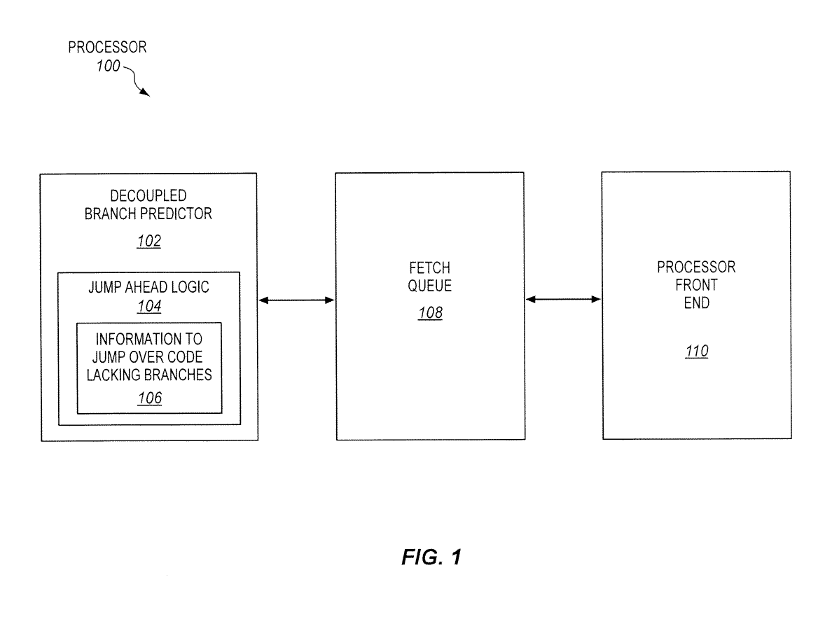

FIG. 1 is a block diagram of an example embodiment of a processor 100. The processor includes a decoupled branch predictor 102, a fetch queue 108, and a processor front end 110. It is to be appreciated that the processor includes other logic (e.g., execution logic, retirement logic, caches, etc.), which is not shown in order to avoid obscuring the description.

The branch predictor 102 may generate predictions that are consumed or utilized by the processor front end 110. The branch predictor typically processes discrete portions of program code having multiple instructions (e.g., fetch blocks, fetch parcels, etc.). By way of example, and not limitation, in some embodiments, a fetch block or fetch parcel may have a fixed length (e.g., they may not have a variable length that begins and ends with a taken branch.) Advantageously, this may help to avoid the need to include additional hardware (e.g., a stream predictor). In one embodiment, a fetch parcel is 32-bytes and may contain up to four control instructions, although this is not required.

In one example embodiment, the branch predictor may predict whether or not there is a branch in a fetch parcel, or other discrete portion of program code, whether the branch will be taken or not, and the destination address and/or program counter of the branch if the branch is predicted to be taken. The branch predictor may include a circuit, functional unit, or other logic (e.g., hardware, software, or a combination) that is operable to predict the directions of branches. The processor front end may use the predictions to change the control flow followed by the processor. For example, the processor front end may include an instruction fetch unit to fetch a set of instructions from a given location based on the predictions, a decoder to decode the fetched instructions, and/or other logic or units to otherwise ready instructions for execution, based on the predictions. In a sense, the branch predictor may steer the processor front end and/or an instruction fetcher of the processor front end via a program counter to different sections of code associated with branches. When the branch direction is actually resolved, update information may be sent back to the branch predictor to update the branch predictor with information consistent with actual committed execution.

In the illustrated embodiment, the branch predictor 102 is a decoupled branch predictor that is decoupled from the processor front end 110 through the intervening fetch queue 108. In particular, an output of the branch predictor is coupled with an input of the fetch queue, and an output of the fetch queue is coupled with an input of the processor front end. The branch predictor may store information including predictions in the fetch queue, and the processor front end may receive the information including the predictions from the intervening fetch queue.

Decoupling the branch predictor from the processor front end with the fetch queue may be advantageous. For one thing, decoupling the branch predictor from the front end may help to allow the branch predictor to operate relatively more independently and/or asynchronously from the processor front end and/or subsequent pipeline stages. This may help to allow the branch predictor to remain ahead of the processor front end in terms of execution. The fetch queue may buffer predictions in case the branch predictor is ahead of the processor front end in terms of execution. The fetch queue may also help to avoid stalls in the processor front end due to instruction cache misses or because of the issue queue is full. Moreover, the fetch queue may help to allow frequency targets to be relaxed for the processor front end. Since the branch predictor is decoupled from the processor front end, the current fetch parcel or other portion of program code being processed by the branch predictor may typically be different from the one being processed by the processor front end at a given time.

As previously mentioned, the branch predictor typically processes discrete portions of program code having multiple instructions. These are commonly referred to as fetch blocks, fetch parcels, etc. By way of example, a fetch block or parcel may have a fixed length, such as, for example, of 32-bytes in one embodiment, although this is not required. These fetch blocks or parcels contain multiple instructions. Significantly, typically not all of the fetch blocks or fetch parcels have a branch. Analysis based on certain types of workloads for fetch parcels having four instructions each seems to indicate that only around half of the fetch parcels on average have a branch instruction. The analysis also indicates that on average there may be on the order of only about 1 to 1.5 branch instructions per fetch parcel and that most (e.g., 80% or more) of fetch parcels have no more than 2 branch instructions. Even for other more branching intensive workloads, it is typically expected that a significant proportion of the fetch blocks or parcels may not have a branch.

Referring again to FIG. 1, the branch predictor has jump ahead logic 104. The jump ahead logic includes information 106 to allow the branch predictor to jump or skip over at least some, a significant proportion, or optionally all, of the fetch parcels or blocks or other discrete portions of code that do not have a branch. Advantageously, by jumping or skipping over at least some, or all, of the fetch parcels that do not have a branch, the branch predictor does not have to process every single fetch parcel. Rather, the branch predictor may process only a subset of the fetch parcels, such as, for example, only the fetch parcels that each have one or more branch instructions. That is, the branch predictor may process only the fetch parcels that contain at least one branch instruction, whereas fetch parcels that do not have a branch instruction may be skipped or jumped over by the branch predictor, without the branch predictor needing to process them. By way of example, skipping or jumping over these fetch parcels may include the program counter skipping or jumping over program counter addresses or values corresponding to these fetch parcels.

In contrast, the front end and execution stages of the processor typically have to traverse and process all of the instructions, from all of the fetch parcels, along the direction of the program flow and/or along the flow of the correct execution path, even when they don't have a branch. In other words, the branch predictor may process only a subset of the fetch parcels that are processed by the front end and/or execution stages of the processor. Since the branch predictor processes less fetch parcels and instructions than the processor front end and/or execution stages, this may help to allow the branch predictor to run ahead of the processor front end and/or execution stages in terms of execution most of the time. The predictions from the branch predictor may be stored and accumulated in the fetch queue 108. The length of the fetch queue in part determines how far ahead of the front end the branch predictor may run. In this way, the branch predictor may provide predictions to the front end in a timely manner which helps to improve processor performance. Additionally, since the branch predictor does not need to process all of the fetch parcels, the amount of power consumed by the branch predictor and/or the amount of heat generated by the branch predictor may both tend to be reduced.

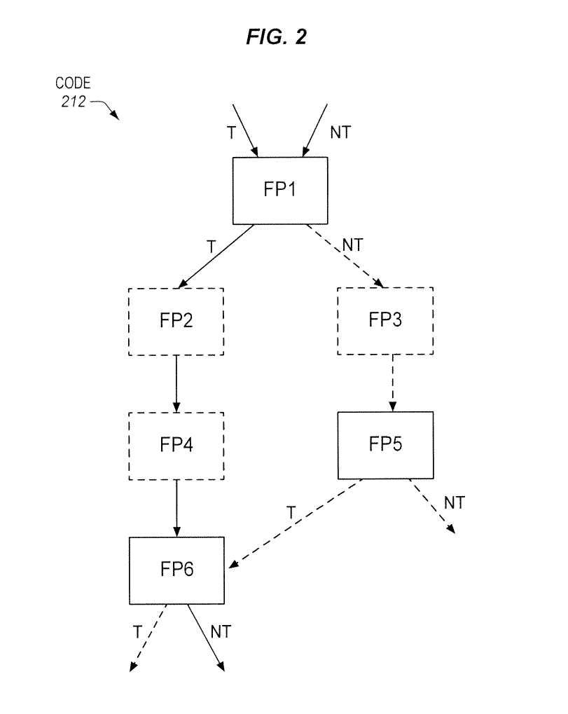

FIG. 2 illustrates an example portion of program code 212 having fetch parcels (FP) with and without branch instructions. A first fetch parcel (FP1), a second fetch parcel (FP2), a third fetch parcel (FP3), a fourth fetch parcel (FP4), a fifth fetch parcel (FP5), and a sixth fetch parcel (FP6) are shown. A subset of the fetch parcels with branch instructions are shown as rectangles with solid lines. Another subset of the fetch parcels without branch instructions are shown as rectangles with dashed lines. Solid lines are used to designate a correct path, whereas dashed lines are used to designate an incorrect path.

Assuming a traversal of the correct path, the branch predictor may only process the first fetch parcel (FP1) and the sixth fetch parcel (FP6). The jump ahead logic may allow the branch predictor to skip or jump over the second parcel (FP2) and the fourth parcel (FP4). In contrast, the processor front end (as well as the execution stage of the pipeline) would have to process all of the first parcel (FP1), the second parcel (FP2), the fourth parcel (FP4), and the sixth parcel (FP6). That is, the processor front end (as well as the execution stage of the pipeline) would need to process more fetch parcels (e.g., in this example about twice as many) as the branch predictor. As previously mentioned, processing less total fetch parcels may help to allow the branch predictor to run ahead of the processor front end.

As will be explained further below, the jump ahead logic and/or the branch predictor may utilize information indicating the fetch parcels that have branches and information indicating distances between the fetch parcels that have the branches. That is, the jump ahead logic may maintain information representing the control flow graph of the program code as it is traversed dynamically. For the illustrated example code, the jump ahead logic may recognize that FP1, FP5, and FP6 have branches, recognize that the next fetch parcel after FP1 is in three fetch parcels for the taken path (i.e., FP6) and in two fetch parcels for the not taken path of FP1 (i.e., FP5).

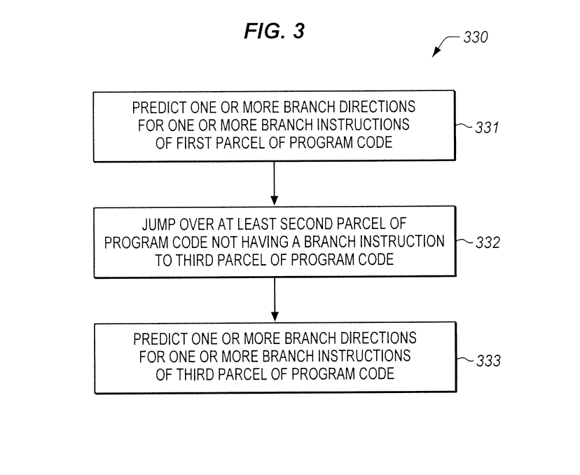

FIG. 3 is a block flow diagram of an example embodiment of invention method of jumping over parcels that omit branches during branch prediction. The method may be performed by a branch predictor, a processor, and/or a computer system.

The method includes predicting one or more branch directions for one or more branch instructions of a first parcel of a program code, at block 331. The method also includes jumping over at least a second parcel of the program code to a third parcel of the program code, the second parcel not having a branch instruction, at block 332. Then, one or more branch directions are predicted for one or more branch instructions of the third parcel of the program code, at block 333.

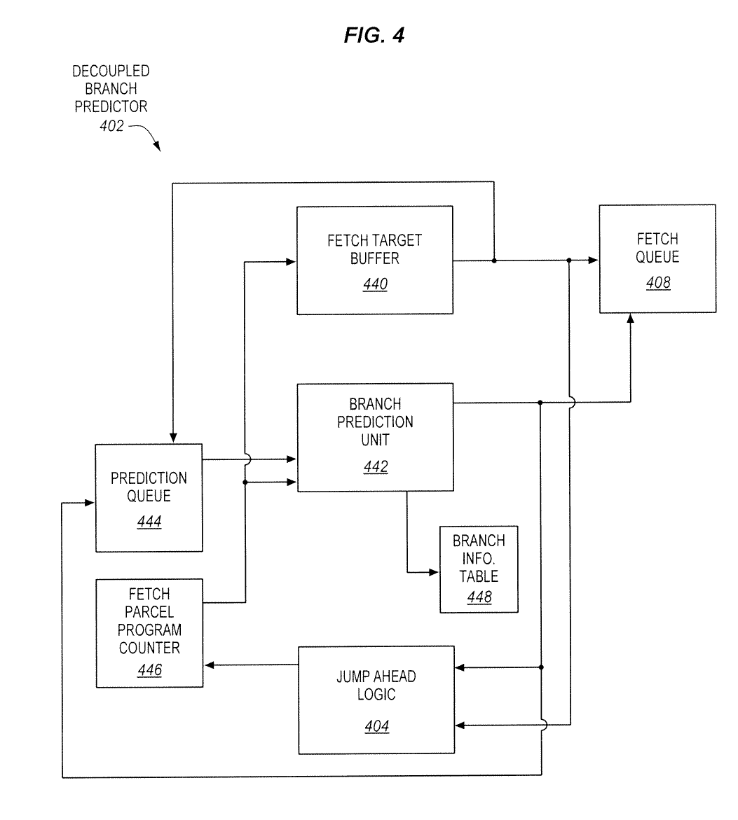

FIG. 4 is a block diagram of an example embodiment of a decoupled branch predictor 402. The branch predictor includes a branch prediction unit (BPU) 442, a fetch target buffer (FTB) 440, a prediction queue (PQ) 444, a branch information table (BIT) 448, a fetch parcel program counter (PC) 446, and an example embodiment of jump ahead logic (JA) 404. The decoupled branch predictor 402 is coupled with a fetch queue 408.

When the prediction queue 444 is empty, the current fetch parcel program counter 446 may be used to access to the fetch target buffer (FTB) 440 and the branch prediction unit (BPU) 442 substantially in parallel. The access to the branch prediction unit may provide information regarding whether the specific branch is predicted to be taken or not. The access to the fetch target buffer may determine whether or not there is information regarding the current fetch parcel by determining whether or not it is represented in the fetch target buffer.

Assuming that the fetch parcel program counter is represented in the fetch target buffer, indicating that there is a branch, the fetch target buffer may output or provide branch information associated with the branch. For example, in one example embodiment, the fetch target buffer may provide at least some or all of: (1) branch position identification information that identifies which instructions in the fetch parcel have a branch; (2) branch type identification information that identifies a type of the branch (e.g., to indicate whether the branch is a direct conditional branch, a direct unconditional branch, or another type of branch, etc.); (3) jump ahead information, according to embodiments of the invention, which indicates to jump or skip over one or more fetch parcels (e.g., indicates how far from the specific fetch parcel is the next one that contains a branch); and (4) destination address identification information that indicates a destination address for the current fetch parcel. In alternate embodiments, either less or more information may optionally be provided.

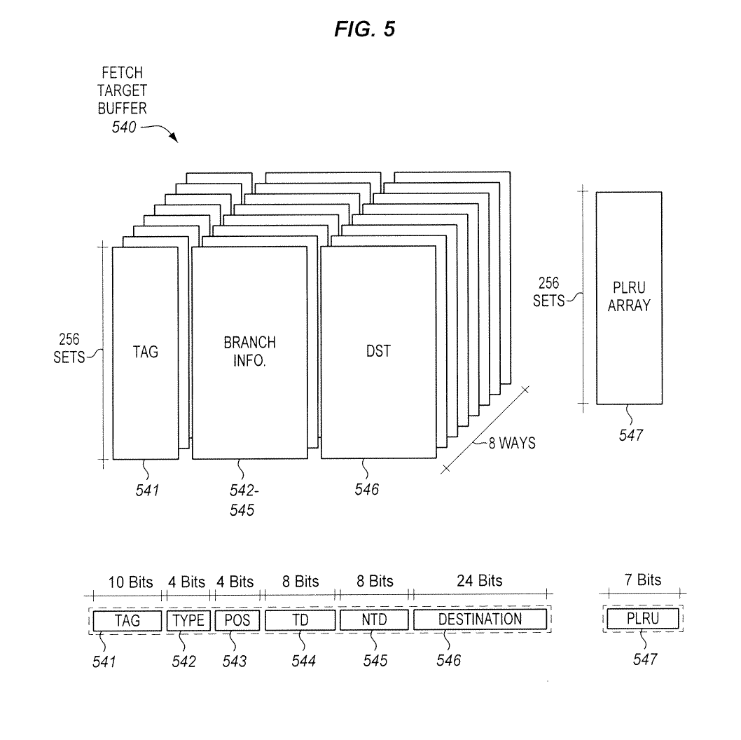

Before proceeding with the description of FIG. 4, it may be helpful to discuss a particular example embodiment of a fetch target buffer and particular examples of the types of information mentioned above. FIG. 5 is a block diagram of an example embodiment of a suitable fetch target buffer (FTB) 540. The fetch target buffer is also sometimes known in the arts as a branch target buffer. The example embodiment fetch target buffer is a 256-set, 8-way associative address cache that is operable to store branch information regarding branches of a fetch parcel. Larger, smaller, or differently arranged fetch target buffers may alternatively be used.

A number of fields are included for each of the entries of the fetch target buffer. The fields include a tag field 541, branch information fields 542-545 and a destination address identification field 546. As shown in the illustrated example embodiment of an entry, the illustrated branch information fields include a branch type identification field (type) 542, a branch position identification field (pos) 543, a taken direction (TD) jump ahead bits field 544, and a not taken direction (NTD) jump ahead bits field 545. The illustrated arrangement of the fields is optional and not required. Moreover, as explained further below, the sizes of the fields are optional and not required.

The tag field 541 may be used to determine whether information for the specific fetch parcel program counter exists in the fetch target buffer. The fetch target buffer may be probed with the fetch parcel program counter. On a tag hit, information for the current fetch parcel may be read out. In the example embodiment, the tag field has 10-bits, although this is not required.

The branch position identification (pos) field 543 identifies which instructions in the fetch parcel have a branch. According to one example embodiment, there may be one branch position identification bit (also referred to herein simply as a position bit) for each possible instruction in the fetch parcel. For example, in an embodiment where the fetch parcel has a fixed length having at most four instructions, there may be four corresponding per-instruction position bits, although the scope of the invention is not so limited. The illustrated position field has 4-bits. Each position bit may have a first bit value (e.g., 1) to indicate that the corresponding instruction is a branch instruction, or a second bit value (e.g., 0) to indicate that the corresponding instruction is not a branch instruction. Alternatively, there may be more or less than four position bits if there are more or less instructions in a fetch parcel.

The branch type identification (type) field 542 identifies, for each of the branches that reside in the associated fetch parcel, the type of the branch they are (e.g., to indicate whether the branch is a direct conditional branch, a direct unconditional branch, or another type of branch, etc.). In the illustrated embodiment, the fetch target buffer is assumed to only handle direct type branches, and accordingly only one per-instruction type bit for each of the possible instructions in the fetch parcel that may contain a branch may be included. Each per-instruction type bit may have a first bit value (e.g., 1) to indicate or designate that the corresponding instruction is a first type of branch instruction (e.g., direct conditional branch), or a second bit value (e.g., 0) to indicate that the corresponding instruction is a second type of branch instruction (e.g., direct unconditional branch). Alternatively, if more types of branch instructions are present in the given architecture, two or more per-instruction type bits may be included to select between more than two types of branches. As previously mentioned, in the illustrated embodiment the fetch parcel may have up to four branch instructions, and accordingly the type field is a 4-bit field with one per-instruction bit per corresponding instruction in the fetch parcel. Alternatively, fetch parcels may have either fewer or more possible branch instructions.

Notice that the fetch target buffer also stores jump ahead information, in the form of a taken direction (TD) jump ahead bits field 544, and a not taken direction (NTD) jump ahead bits field 545. The jump ahead bit fields may indicate or specify that one or more fetch parcels, which do not have branches, are to be jumped or skipped over by a branch predictor. In the particular illustrated example embodiment, in which a fetch parcel may have up to four possible branch instructions, and each branch instruction may have a taken branch direction (TD), or a not taken branch direction (NTD), eight taken direction (TD) bits may be provided, and eight not take direction (NTD) bits may be provided. Four sets of two bits each of the taken direction (TD) bits may respectively correspond to each of the four possible branch instructions in a fetch parcel. Likewise, four sets of two bits each of the not take direction (NTD) bits may respectively correspond to each of the four possible branch instructions in the fetch parcel. Alternatively, more or less than four sets each may be provided if more or less possible branch instructions respectively may be included in a fetch parcel. Moreover, in another alternate embodiment, as few as two not taken direction (NTD) bits may optionally be provided, since the not taken direction path implies that all branches of the fetch parcel has to be not taken. This may reduce the number of bits that are stored, but is optional and not required.

Each of the two bit sets may have one of four possible values to indicate a distance from the associated fetch parcel to the next fetch parcel having a branch. According to one possible convention, a two bit value of 00 may represent a zero skip or jump distance (e.g., the next sequential fetch parcel is to be processed and/or there are back-to-back/adjacent fetch parcels with branches), a value of 01 may represent a one fetch parcel skip or jump distance (e.g., one intermediate fetch parcel is to be jumped or skipped over), a value of 10 may represent a two fetch parcel skip or jump distance (e.g., two back-to-back/adjacent intermediate fetch parcels are to be jumped or skipped over), and a value of 11 may represent a three fetch parcel skip or jump distance (e.g., three intermediate back-to-back/adjacent intermediate fetch parcels are to be jumped or skipped over). Alternatively, in other embodiments, either fewer or more bits (e.g., a single bit, or three or more bits may be used) may be used to respectively indicate smaller or larger jump distances. Moreover, as previously described, fewer or more than four instructions may be present in a fetch parcel, and correspondingly fewer or more sets of per-instruction jump ahead bits may be provided.

The destination address identification field 546 indicates a destination address for the current fetch parcel. In one aspect, the whole destination address may optionally be stored. Alternatively, it is not necessary to hold the whole destination address, since the rest of the bits may be directly extracted from the branch address. The illustrated destination field is 24-bits, although this is not required.

The fetch target buffer also contains a small pseudo least recently used (PLRU) information array that holds PLRU information for each of the sets of the main fetch target buffer array. Since there are eight ways, each entry in the PLRU array may have seven bits. On an update in the fetch target buffer, the PLRU bits may be updated and in case a replacement is deemed appropriate, they may be consulted in order to identify the appropriate way to victimize.

Now that a particular example embodiment of a fetch target buffer, and particular examples of the types of information that may be stored in the fetch target buffer have been described, let's return to the description of FIG. 4. Refer again to FIG. 4, once the branch predictor 402 determines that a branch has been taken, it gets the starting address (e.g., the branch target) of the next block of code. The fetch target buffer 440 stores the fetch or branch targets of previously executed branches, so when a branch is taken, the branch predictor determines the branch target address from the fetch target buffer and this branch target address is provided to the front end so that the front end may begin fetching instructions from that address. In the event of an unconditional branch, the next fetch parcel program counter may be the destination address of the unconditional branch, and the in-flight prediction of the branch prediction unit may also be canceled. In the event of a fetch target buffer miss, the in-flight prediction of the branch prediction unit may be cancelled, and the next sequential fetch parcel program counter may be used.

Assuming that the fetch parcel program counter is represented in the fetch target buffer, indicating that there is a branch, the fetch target buffer may output or provide branch information associated with the branch. The branch position identification information (e.g., the pos bits) and branch type identification information (e.g., the type bits) may be provided from the fetch target buffer to the prediction queue. The prediction queue may also receive the fetch parcel program counter.

The prediction queue may help to transform the output of the fetch target buffer, to output that is appropriate for the branch prediction unit. The output of the fetch target buffer is per fetch parcel and consequently the fetch target buffer may provide output information for multiple branches per cycle (e.g., in one embodiment up to four branches). On the other hand, the branch prediction unit, in the illustrated example embodiment, processes only one branch per cycle. If there are position bits, this may mean that there is more than one branch in the fetch parcel. In one embodiment the prediction queue may include an internal queue to perform intermediate buffering in cases where more than one branch exists in the current fetch parcel. Representatively, in an embodiment where the fetch parcel may have up to four branch instructions, the prediction queue may have three queue entries, or more if desired.

The prediction queue may create a branch program counter for one or more additional branches indicated to be present in the current fetch parcel. This information may then be used to sequentially access the branch prediction unit and generate one or more additional predictions for the current fetch parcel. The branch prediction unit may use any one of a number of different types of branch prediction algorithms to predict branches based on a programs past behavior, and the scope of the invention is not limited to any known such algorithm. Predictions for the current fetch parcel may be stopped if any of the branches is predicted as taken. The predictions from the branch prediction unit may then be collected along with the information provided for the branches in the fetch parcel. When all the branches from a given fetch parcel are removed from the prediction queue a signal may be provided to assemble all the information for a given fetch parcel. The output of the prediction queue may include the branch program counter for each of the branches in the fetch parcel, and whether the branch was conditional or not. This accumulated information may be stored in the fetch queue. As previously mentioned, the fetch queue may be used to communicate control flow information to the processor front end.

Referring again to FIG. 4, the branch predictor has jump ahead logic 404. As shown in the illustration, a first input of the jump ahead logic 404 is coupled with an output of the fetch target buffer 440, and a second input of the jump ahead logic 404 is coupled with an output of the branch prediction unit 442. An output of the jump ahead logic is coupled with an input of the fetch parcel program counter 446.

As previously mentioned, in embodiments of the invention, the jump ahead logic may be used to jump or skip over at least some, a significant proportion, or optionally all, of the fetch parcels or blocks that do not have a branch. Advantageously, by jumping or skipping over at least some, or all, of the fetch parcels that do not have a branch, the branch predictor does not have to process every single fetch parcel. Rather, the branch predictor may process only a subset of the fetch parcels, such as, for example, only the fetch parcels that each have one or more branch instructions. That is, the branch predictor may process only the fetch parcels that contain at least one branch instruction. Fetch parcels that do not have a branch instruction may be skipped or jumped over by the branch predictor without the branch predictor needing to process them. By way of example, skipping or jumping over these fetch parcels may include the program counter skipping or jumping over program counter addresses or values corresponding to these fetch parcels.

In contrast, typically the front end and execution stages of the processor typically have to traverse and process all of the instructions from all of the fetch parcels along the direction of the program flow and/or along the flow of the correct execution path even when they don't have a branch. In other words, the branch predictor may process only a subset of the fetch parcels that are processed by the front end and/or execution stages of the processor. Since the branch predictor processes less fetch parcels and overall instructions than the processor front end and/or execution stages, this may help to allow the branch predictor to most of the time run ahead of the processor front end and/or execution stages in terms of execution. The predictions from the branch predictor may be stored and accumulated in the fetch queue. The length of the fetch queue in part determines how far ahead of the front end the branch predictor may run. In this way, the branch predictor may provide predictions to the front end in a timely manner which helps to improve processor performance. Additionally, since the branch predictor does not need to process all of the fetch parcels, the amount of power consumed by the branch predictor and/or the amount of heat generated by the branch predictor may both tend to be reduced.

As previously mentioned, the fetch target buffer 440 may store jump ahead bits 544, 545 that indicate to jump or skip over one or more fetch parcels that do not have branches. The jump ahead bits may be stored in each of the fetch target buffer entries. Alternatively, the jump ahead bits may be stored in another location besides the fetch target buffer, such as, for example, in a dedicated buffer, register, or other storage location within or accessible by the branch predictor. In embodiments of the invention, the jump ahead bits may indicate how far from the current fetch parcel is the next fetch parcel that contains at least one branch and/or distances between fetch parcels each having at least one branch. In embodiments of the invention, jump ahead bits may be provided to indicate these distances for each for each of a plurality of possible branch instructions and branch directions in a fetch parcel.

By way of example, in one particular example embodiment in which a fetch parcel may have up to four possible branch instructions, and each branch instruction may have a taken branch direction (TD) or a not taken branch direction (NTD), eight taken direction (TD) bits may be provided and eight not take direction (NTD) bits may be provided. Four sets of two bits each of the taken direction (TD) bits may respectively correspond to each of the four possible branch instructions in a fetch parcel. Likewise, four sets of two bits each of the not take direction (NTD) bits may respectively correspond to each of the four possible branch instructions in the fetch parcel. Alternatively, in another embodiment, as few as two not taken direction (NTD) bits may optionally be provided, since the not taken direction path implies that all branches of the fetch parcel has to be not taken.

Each of the two bit sets may have one of four possible values to indicate a distance from the associated fetch parcel to the next fetch parcel having a branch. According to one possible convention, a two bit value of 00 may represent a zero skip or jump distance (e.g., the next sequential fetch parcel is to be processed and/or there are back-to-back/adjacent fetch parcels with branches), a value of 01 may represent a one fetch parcel skip or jump distance (e.g., one intermediate fetch parcel is to be jumped or skipped over), a value of 10 may represent a two fetch parcel skip or jump distance (e.g., two back-to-back/adjacent intermediate fetch parcels are to be jumped or skipped over), and a value of 11 may represent a three fetch parcel skip or jump distance (e.g., three intermediate back-to-back/adjacent intermediate fetch parcels are to be jumped or skipped over). Alternatively, in other embodiments, either fewer or more bits (e.g., a single bit, or three or more bits) may be used to respectively indicate smaller or larger jump distances.

In case the actual distance between fetch parcels with branches is larger than can be represented in the available number of possible values, the maximum jump or skip value which may be represented may be used. Because fetch parcels that contain a branch are not skipped over, this approach does not sacrifice correctness, but rather may tend to sacrifice a small portion of the potential benefit. However, since architectural studies seem to indicate that the vast majority of the distances between fetch parcels with branches are relatively small (e.g., typically less than a jump over three intervening fetch parcels), the loss of benefit is generally believed to be acceptably small.

The jump ahead bits output from the fetch target buffer 440 may be provided as input to the jump ahead logic 404. The prediction for the last branch for which a prediction was made in the current fetch parcel may also be output from the branch prediction unit 442 and provided as input to the jump ahead logic 440. The jump ahead logic may be operable to use the jump ahead bits to determine the next fetch parcel program counter corresponding to a fetch parcel having a branch. The prediction from the branch prediction unit 442 may be used to determine whether TD or NTD jump ahead bits are used for the branch. By way of example, the skip or jump distance indicated in the jump ahead bits may represent an offset that may be added to the current fetch parcel program counter so as to get the next fetch parcel program counter corresponding to a fetch parcel having a branch. By way of example, for the specific jump ahead bits mentioned above, a value of 01 may cause the jump ahead logic to increment the fetch parcel program counter by an amount sufficient to jump over one sequential fetch parcel (e.g., increment the fetch parcel program counter by 64-bytes in the case of 32-bit fetch parcels).

Because at the prediction stage the jump ahead bits are generally not available, since they are to be read from the fetch target buffer, the jump ahead logic may only alter the current fetch parcel for distances greater than one fetch parcel if the not taken path is followed, which in an aspect may be the default path that the prediction stage follows. Since accesses to the fetch target buffer are commonly pipelined, by the time the distance to the next fetch parcel with a branch is known, the access to the fetch target buffer for the next sequential fetch parcel generally has already been initiated. As such, if the distance is one fetch parcel, there may be no need to skip one fetch parcel, as the fetch parcel program counter may already have been advanced. However, on a direct taken branch or on a re-steer from a branch misprediction, distances for both the taken and not taken paths may be used.

In some embodiments, the branch predictor may be used in a processor and/or an architecture that allows for self-modifying code. The self-modifying code may cause the control flow graph to change and the jump ahead logic may be adjusted to account for the change to the control flow graph caused by the self-modifying code. The self-modifying code may cause the distance between two branches to either be larger or smaller than initially. In the event that the distance becomes larger than it was initially, the change will not be problematic and will be remedied after the first execution of the two fetch parcels with a branch. The jump ahead bits will be updated and the new distance will be learned. In the event that the distance becomes smaller than it was initially, this may tend to cause a misfetch to occur, since a fetch parcel may be jumped over. Upon detection of the misfetch, the fetch target buffer may be updated to accommodate for the change (e.g., the jump ahead bits may be changed to accommodate for the change). Alternatively, in other embodiments, the branch predictor may be used in a processor and/or an architecture that does not allow for self-modifying code.

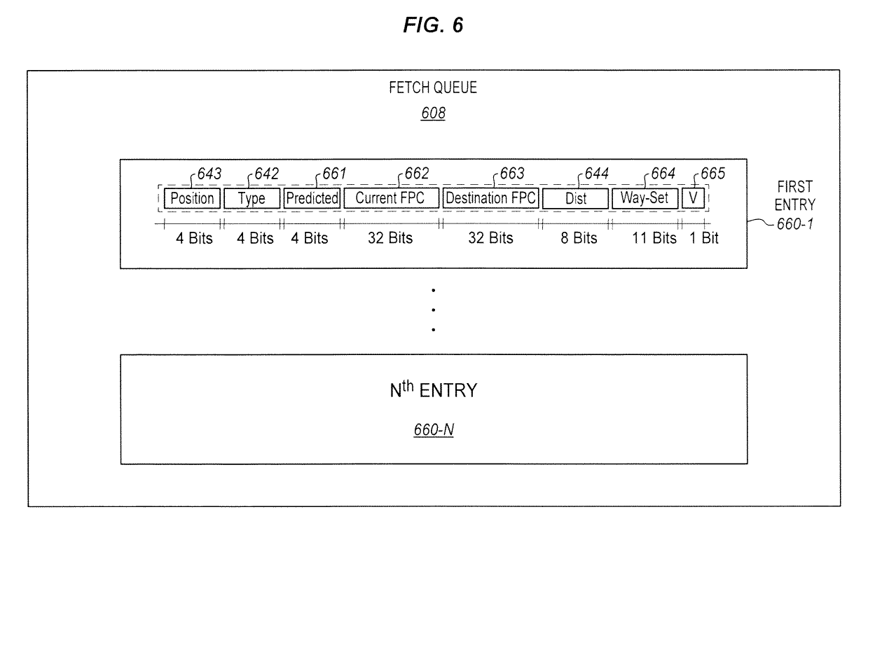

FIG. 6 is a block diagram of an example embodiment of a suitable fetch queue 608. As previously mentioned, the fetch queue is the component that feeds the predictions made by the branch predictor to the front end, which consumes the predictions. When the branch predictor makes a prediction for all the branches in a fetch parcel, it provides or stores this information to an entry in the fetch queue. The illustrated fetch queue has a first entry and an Nth entry 660-N. In one particular example embodiment, the fetch queue may hold branch information for four fetch parcels, although fewer or more may alternatively be used.

Information that may be included in an entry of the fetch queue, in accordance with an example embodiment of the invention, is shown for the first entry 660-1. The information includes the position identification bits 643 and type identification bits 642. These may be used to check at a misfetch stage of the pipeline stage whether there was a misfetch or not. Additionally, the fetch parcel program counter 662 that triggered the predictions is also provided, so that at the fetch stage it can be determined whether the entry should be consumed or not. If any of the branches was predicted taken, the destination fetch parcel program counter 663 as predicted by the fetch target buffer is placed in the corresponding field. If the fetch target buffer contained distance information for the alternate path from the prediction, this is place in the distance (dist) field 644. Notice that it is the alternate path from the prediction which is stored. For example, if all of the branches were predicted not taken, all the taken direction (TD) bits may be stored in the distance (dist) field 644. These opposite path jump ahead bits may travel along with the instruction and be returned back to the branch predictor in the event of mispeculation. In case of misprediction, the front-end and the branch predictor should be re-steered to the correct address. These opposite path jump ahead bits may be used by the jump ahead logic to help the branch predictor to jump over fetch parcels starting at the re-steered correct address that do not have branches. For example, the re-steered address of the branch predictor may be computed as the re-steered address plus the opposite path jump ahead bits that have been returned back from the backend. Since these are opposite path jump ahead bits, and since the path previously taken was determined to be incorrect, these opposite path jump ahead bits are the relevant ones to use and may be returned back to the branch predictors. Advantageously, this may help the branch predictor to resume making predictions ahead of the processor front end, even in the event of such a misprediction. However, this is optional and not required. Also the way-set 664 of the entry that produced the prediction is appended, for updating the jump ahead logic. When all the information is ready to be probed by the fetch stage the valid bit (V) 665 is set to 0.

In some embodiments, when the fetch queue is full, there is no point in making more predictions and thus wasting power. As such, power to the whole branch predictor 102, 402 may optionally be reduced when the fetch queue is full or sufficiently full (e.g., power to the branch predictor may be clock gated based on a full or sufficiently full indication signal from the fetch queue). Later, when the fetch queue is no longer full, the branch predictor may resume making predictions. This is optional and not required.

At the processor front end 110, when the next fetch parcel program counter is to be generated, the current fetch parcel program counter is checked against the current fetch parcel program counter of the entry that resides at the top of the fetch queue. If the two match, then this may mean that the control flow of the front end should change. The entry may be output from the fetch queue and its contents may be used to generate the next fetch parcel program counter. More specifically, if the branch residing in the fetch parcel is predicted to be taken, the program counter of the next fetch parcel may be that of the destination fetch parcel program counter as read from the fetch queue entry. If the branch was predicted not taken, the next fetch parcel program counter may be the next sequential one. If an entry is consumed from the fetch queue, the fetch parcel which is fetched based on it may be marked as predicted, and the branch information corresponding to it may be associated with the fetch parcel. This may help to detect inconsistencies of the fetch target buffer and help to update the branch prediction unit.

The processor may also include logic along with the jump ahead logic 404 that keeps track of the runtime behavior and records jump ahead information. When a prediction for a fetch block is made, both the jump ahead bits (both the TD and NTD bits) and the way-set of the prediction are sent to the main pipeline. Initially, all TD and NTC jump ahead bits may be zero, such that they do not affect the next fetch parcel program counter. When a hit occurs in the fetch target buffer and all the branches in the fetch block are predicted to be not taken, the way-set of the fetch target buffer entry along with the prediction are propagated to the front-end. In case of a taken prediction, the way-set of the taken prediction is propagated instead. This information is stored in a register in the decode stage, which hold the way-set and the prediction (taken or not taken). Additionally a saturating jump ahead counter (e.g., a two-bit saturating jump ahead counter in the event of two per-instruction jump ahead bits) is set to zero. On every fetch block that gets decoded and does not contain a branch instruction, the jump ahead counter may be incremented by one. The jump ahead counter may be incremented for each fetch parcel decoded by the decoder between fetch parcels having branches along the path of execution (e.g., the jump ahead counter may count the number of fetch parcels without branches between fetch parcels with branches that are to be jumped over). The decoder may keep track of the last set-way that hits on the fetch target buffer as well as the direction of the last branch. When the next fetch block with a branch is decoded, depending on the direction of the previous branch, the fetch target buffer may be updated for the way-set and the direction of the first branch, along with the jump ahead counter that holds the distance to the next fetch parcel. The jump ahead counter may then be reset and the new information may be stored.

Although during decoding there is limited information regarding whether the branch was in the correct or the wrong path, this doesn't matter because even if it is the wrong path the processor is merely learning a part of the control flow graph that is not needed. Also, the jump ahead counter is reset and the information is pushed back in the fetch target buffer when a re-steer because of an indirect branch occurs, since we do not want the jump ahead logic to skip fetch parcels that change the flow of execution. Also, on a pipeline flush after a misprediction or exception, the information at the decode stage may be deleted.

At the decode stage, when information regarding the branches that are contained in a specific fetch parcel are known, a hardware structure may check whether there is a discrepancy between the predicted information provided by the branch prediction unit and reality. A mismatch in the two may cause the branch prediction unit to be adjusted (in case the mismatch was not due to the branch prediction unit lagging) and an internal logic to the front-end may re-steer and result in a flush of the fetch queue. Branches may then be processed in the back-end of the processor, so that if the prediction was correct, the branch prediction unit may be updated accordingly, or in case of a misprediction the speculative state of the branch prediction unit may be corrected. Note that differently from a non-decoupled branch predictor configuration, on a misprediction and on an exception the fetch queue may be flushed, along with the rest of the pipeline.

Conventionally in branch predictors there is no provision for handling branches that occur after a misprediction and/or exception. In embodiments of the invention, a branch predictor may determine whether or not the main pipeline should be stalled briefly (e.g., for one cycle) so as to ensure that the branch predictor is able to go ahead of the main pipeline.

Since on average only about out of two fetch parcels contains a branch, the a branch predictor equipped with the jump ahead logic may generally be able to hide practically all misfetches due to the branch predictor lagging behind the front end. The fetch queue helps to ensure that given some period where the branch predictor is able to produce information for fetch parcels with a branch at faster rate than what the front end consumes them, even if this is reversed temporarily (e.g., the front end consumes at a higher rate than the branch predictor can generate), misfetches should not significantly occur. The size of the fetch queue in part determines how far ahead the branch predictor can be from the front end. In some embodiments, the fetch queue may have at least 12, at least 14, or at least 16 entries. Fewer entries may be used, if desired, but may tend to result in more misfetches.

Embodiments of the invention pertain to a system (e.g., a desktop, laptop, computer system, server, cell phone, set top box, or other electronic device) having one or more processors as disclosed herein and/or performing a method as disclosed herein.

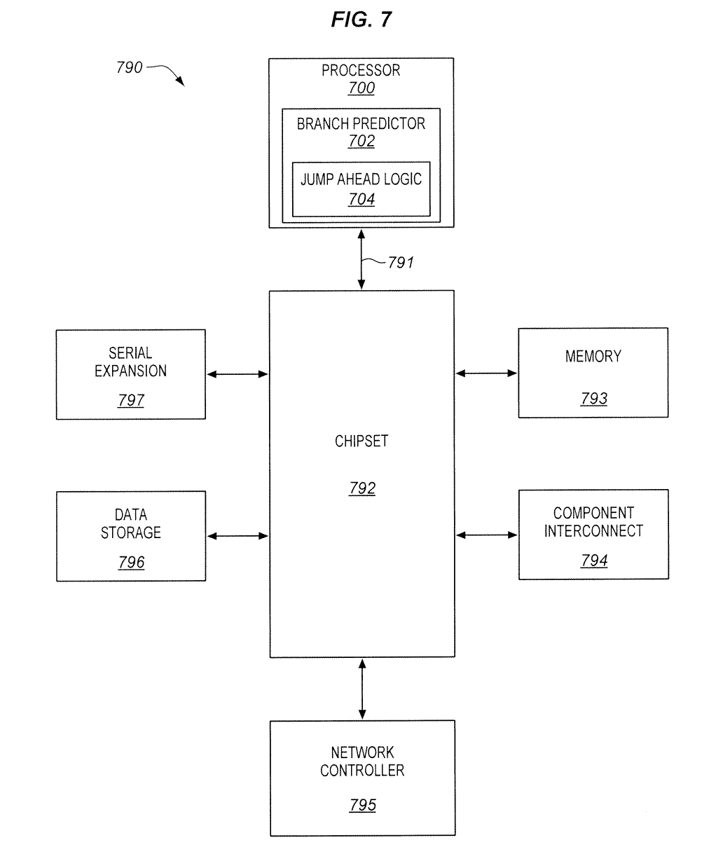

FIG. 7 is a block diagram of an example embodiment of a computer system or electronic device 790 suitable for incorporating embodiments of the invention. The computer system includes a processor 700. The processor may have one or more cores. In the case of a multiple core processor, the multiple cores may be monolithically integrated on a single integrated circuit (IC) chip or die. In one aspect, each core may include at least one execution unit and at least one cache. The processor may also include one or more shared caches.

In one particular embodiment, the processor may include an integrated graphics controller, an integrated video controller, and an integrated memory controller that are each monolithically integrated on a single die of the general-purpose microprocessor, although this is not required. Alternatively, some or all of these components may be located off-processor. For example, the integrated memory controller may be omitted from the processor and the chipset may have a memory controller hub (MCH).

In embodiments of the invention, the processor includes a branch predictor 702 having jump ahead logic 704 that is operable to allow the branch predictor to jump over fetch parcels or other portions of program code that do not have branches. In embodiments, decoders and/or execution units (not shown) of the processor may not be able to jump over these fetch parcels or program code portions.

The processor is coupled to a chipset 792 via a bus (e.g., a front side bus) or other interconnect 791. The interconnect may be used to transmit data signals between the processor and other components in the system via the chipset. A memory 793 is coupled to the chipset. In various embodiments, the memory may include a random access memory (RAM). Dynamic RAM (DRAM) is an example of a type of RAM used in some but not all computer systems. The memory may store program code to be processed by the processor.

A component interconnect 794 is also coupled with the chipset. In one or more embodiments, the component interconnect may include one or more peripheral component interconnect express (PCIe) interfaces. The component interconnect may allow other components to be coupled to the rest of the system through the chipset. One example of such components is a graphics chip or other graphics device, although this is optional and not required.

A data storage 796 is coupled to the chipset. In various embodiments, the data storage may include a hard disk drive, a floppy disk drive, a CD-ROM device, a flash memory device, a dynamic random access memory (DRAM), or the like, or a combination thereof. A network controller 795 is also coupled to the chipset. The network controller may allow the system to be coupled with a network. A serial expansion port 797 is also coupled with the chipset. In one or more embodiments, the serial expansion port may include one or more universal serial bus (USB) ports. The serial expansion port may allow various other types of input/output devices to be coupled to the rest of the system through the chipset.

A few illustrative examples of other components that may optionally be coupled with the chipset include, but are not limited to, an audio controller, a wireless transceiver, and a user input device (e.g., a keyboard, mouse). In one or more embodiments, the computer system may execute a version of the WINDOWST™ operating system, available from Microsoft Corporation of Redmond, Wash. Alternatively, other operating systems, such as, for example, UNIX, Linux, or embedded systems, may be used.

This is just one particular example of a suitable computer system. Other system designs and configurations known in the arts for laptops, desktops, handheld PCs, personal digital assistants, engineering workstations, servers, network devices, network hubs, switches, video game devices, set-top boxes, and various other electronic devices having processors, are also suitable. In some cases, the systems may have multiple processors.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known circuits, structures, devices, and operations have been shown in block diagram form or without detail in order to avoid obscuring the understanding of the description.

It will also be appreciated, by one skilled in the art, that modifications may be made to the embodiments disclosed herein, such as, for example, to the configurations, functions, manner of operation, and use, of the components of the embodiments. All equivalent relationships to those illustrated in the drawings and described in the specification are encompassed within embodiments of the invention. Where considered appropriate, reference numerals or terminal portions of reference numerals have been repeated among the figures to indicate corresponding or analogous elements, which may optionally have similar characteristics.

Various operations and methods have been described. Some of the methods have been described in a basic form in the flow diagrams, but operations may optionally be added to and/or removed from the methods. In addition, while the flow diagrams show a particular order of the operations according to example embodiments, it is to be understood that that particular order is exemplary. Alternate embodiments may optionally perform the operations in different order, combine certain operations, overlap certain operations, etc. Many modifications and adaptations may be made to the methods and are contemplated.

It should also be appreciated that reference throughout this specification to “one embodiment”, “an embodiment” or “one or more embodiments”, for example, means that a particular feature may be included in the practice of the invention. Similarly, it should be appreciated that in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

What is claimed is:

1. A processor comprising:
front end logic to process parcels of program code, each of the parcels having multiple instructions;
a branch predictor coupled with the front end logic, the branch predictor to predict directions of branch instructions of the program code; and
jump ahead logic to cause the branch predictor to jump over at least one parcel of the program code that does not have a branch instruction between parcels of the program code that each have at least one branch instruction.

2. The processor of claim 1, wherein the branch predictor comprises a branch prediction unit and a fetch target buffer, and wherein the at least one parcel that does not have the branch instruction is not used to access the branch prediction unit or the fetch target buffer.

3. The processor of claim 1, wherein the branch predictor comprises a fetch target buffer, and wherein the fetch target buffer is to store jump ahead information indicating that the branch predictor is to jump over the at least one parcel that does not have the branch instruction.

4. The processor of claim 3, wherein the jump ahead information indicates a number of a plurality of parcels not having branch instructions that the branch predictor is to jump over between a given parcel having a branch instruction and a next parcel having a branch instruction.

5. The processor of claim 1 wherein the branch predictor is to store and to use taken direction (TD) jump ahead bits and not taken direction (NTD) jump ahead bits for each of a plurality of possible branch instructions in a parcel.

6. The processor of claim 1, wherein the jump ahead logic is to cause a fetch parcel program counter of the branch predictor to be incremented to jump from an initial parcel to a destination parcel by jumping over the intervening at least one parcel that does not have the branch instruction.

7. The processor of claim 1, wherein the front end logic comprises a saturating counter to be incremented upon encountering the parcel that does not have the branch instruction.

8. The processor of claim 1, wherein the front end logic is to process the at least one parcel that does not have the branch instruction.

9. The processor of claim 1, further comprising a fetch queue coupled between the front end logic and the branch predictor.

10. The processor of claim 1, wherein the front end logic comprises at least one of fetch logic to fetch the parcels and a decoder to decode the instructions of the parcels.

11. A method comprising:
predicting one or more branch directions for one or more branch instructions of a first parcel of a program code;
jumping over at least a second parcel of the program code to a third parcel of the program code, the second parcel not having a branch instruction; and
predicting one or more branch directions for one or more branch instructions of the third parcel of the program code.

12. The method of claim 11, wherein predicting the branch directions for the first and third parcels includes accessing a branch prediction unit and a fetch target buffer for the first and third parcels, and wherein the branch prediction unit and the fetch target buffer are not accessed for the second parcel.

13. The method of claim 11, wherein jumping over the second parcel is performed based on jump ahead information accessed from a fetch target buffer, the jump ahead information indicating to jump over the second parcel.

14. The method of claim 13, wherein jumping includes jumping over a plurality of parcels not having branch instructions, and wherein the jump ahead information specifies a number of the plurality of parcels.

15. The method of claim 11, wherein jumping over the second parcel comprises incrementing a fetch parcel program counter used by a branch predictor to jump over the second parcel.

16. The method of claim 11, further comprising decoding instructions of the second parcel.

17. A system comprising:
a processor including:
a decoder to decode parcels of program code, each of the parcels having multiple instructions;
a branch predictor coupled with the decoder, the branch predictor to predict directions of branch instructions of the program code; and
logic to cause the branch predictor to skip over at least one parcel of the program code that does not have a branch instruction between parcels of the program code that each have at least one branch instruction; and
a dynamic random access memory coupled with the processor to store the program code.

18. The system of claim 17, wherein the branch predictor comprises a branch prediction unit and a fetch target buffer, and wherein the at least one parcel that does not have the branch instruction is not used to access the branch prediction unit or the fetch target buffer, but the parcels of the program code that each have at least one branch instruction are used to access the branch prediction unit and the fetch target buffer.

19. The system of claim 17, wherein the branch predictor comprises a fetch target buffer, and wherein the fetch target buffer is to store information indicating that the branch predictor is to skip over the at least one parcel that does not have the branch instruction.

20. The system of claim 17, wherein the logic is to cause a program counter of the branch predictor to be incremented to skip over the at least one parcel that does not have the branch instruction.

21. The processor of claim 1, further comprising a fetch queue coupled between the front end logic and the branch predictor, and wherein the branch predictor is to store jump ahead bits for an alternate path from that predicted by the branch predictor in the fetch queue.

22. The method of claim 11, further comprising:
providing opposite path jump ahead bits, which are for an alternate path than that predicted, from a branch predictor to a processor front end; and
responsive to a misprediction, returning the opposite path jump ahead bits to the branch predictor to allow the branch predictor.
